(19) United States
(12) Patent Application Publication
(10) Pub. No.: US 2019/0303187 A1
(43) Pub. Date: Oct. 3, 2019

(54) METHODS, DEVICES, AND SYSTEMS FOR DISTRIBUTING SOFTWARE TO AND DEPLOYING SOFTWARE IN A TARGET ENVIRONMENT

(71) Applicant: The United States of America as represented by the Secretary of the Navy, San Diego, CA (US)

(72) Inventors: Jeff Vu, San Diego, CA (US); Viral Bhalodia, San Diego, CA (US); Daniel Silva, San Diego, CA (US); Haiqiao Lin, San Diego, CA (US); Samia Fatima Ali, San Diego, CA (US)

(21) Appl. No.: 15/939,500

(22) Filed: Mar. 29, 2018

(51) Int. Cl. G06F 9/455; G06F 8/61; G06F 8/41; G06F 8/70

(52) U.S. Cl. CPC G06F 9/45558; G06F 8/61; G06F 8/41; G06F 2009/45575; G06F 2009/45562; G06F 2009/4557; G06F 8/70

(57) ABSTRACT

Software is deployed in a target environment. Source code that is part of a source software package is received from a source environment that is remote from the target environment. The source code is integrated in the target environment into executable binary files using target continuous integration (CI) architecture that is a replica of source CI architecture used to integrate the source code in the source environment. The executable binary files are deployed in the target environment using continuous deployment (CD) architecture that is a replica of source CD architecture used to deploy the source code in the source environment. The target CI architecture and CD architecture are included in containers in the target environment.

### FEDERALLY-SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil, referencing NC 105005.

### FIELD OF THE INVENTION

The present invention pertains generally to software distribution and deployment. More particularly, the present invention pertains to distributing software from a source environment to a remote target environment and deploying the software in the remote target environment.

### BACKGROUND OF THE INVENTION

In a given enterprise, such as a company or a government organization, there are hundreds of different environments in which software needs to run. Many software systems are very complex, consisting of a myriad of services spread out across multiple servers and computing devices. Using the Navy as an example, the Navy uses large, well-connected computing environments running on shore and small networks of computing devices operating aboard single vessels. Complex distributed computing environments, accompanied with ever rising cyber security threats, make the area of software deployment extremely complex and challenging.

Traditionally, trained engineers have been used to install software across the various devices in a computing network. However, in addition to initial software deployment, software updates need to be regularly installed with minimal delays. Relying on trained engineers makes the installation of software updates very difficult because of cost concerns and the sheer number of computing environments.

In recent years, significant resources have been invested into improving the distribution of software through the implementation of development operating (DevOps) principles. DevOps refers to the automation of software delivery and infrastructure changes. Instead of relying on trained engineers to perform time-consuming software installations, DevOps promotes the use of various tools to facilitate automated installations from a central repository.

On the production side, software must be bug-free, with consistent and reliable operation. Seamless flow of code from development, through deployment, to the testing and production of software is essential for effective software development and deployment. A bottleneck in any of these phases leads to delayed schedules, increased cost, and poor performance.

Bottlenecks frequently occur in the deployment phase due to various factors. For example, the prevalence of Agile processes and commitment to solid software engineering practices has increased not only code quality but also increased throughput and thereby put enormous pressure on the deployment end of the software development lifecycle to keep pace. Also, the necessity to comply with numerous standards, address cyber security concerns, and support different enclaves has slowed deployment drastically.

In view of the above, it would be desirable to have an efficient, user-friendly, and secure system for distributing and deploying software.

### SUMMARY OF THE INVENTION

According to an illustrative embodiment, software is deployed in a target environment. Source code that is part of a source software package is received from a source environment that is remote from the target environment. The source code is integrated in the target environment into executable binary files using target continuous integration (CI) architecture that is a replica of source CI architecture used to integrate the source code in the source environment. The executable binary files are deployed in the target environment using continuous deployment (CD) architecture that is a replica of source CD architecture used to deploy the source code in the source environment. The target CI architecture and CD architecture are included in containers in the target environment.

These, as well as other objects, features and benefits will now become clear from a review of the following detailed description, the illustrative embodiments, and the accompanying drawings.

### BRIEF DESCRIPTION OF THE DRAWINGS

The novel features of the present invention will be best understood from the accompanying drawings, taken in conjunction with the accompanying description, in which similarly-referenced characters refer to similarly-referenced parts, and in which:

FIG. 1 illustrates an example of a secure DevOps deployment architecture for distributing and deploying software according to illustrative embodiments.

FIG. 2 depicts a user interface screen showing a pictorial representation of a service including dependencies according to illustrative embodiments.

FIG. 3 depicts a user interface screen for monitoring containers according to illustrative embodiments.

FIG. 4 depicts a user interface screen for building a microservice image according to illustrative embodiments.

FIG. 5 depicts a user interface screen for creating a service and selecting a port for deployment according to illustrative embodiments.

FIG. 6 depicts a user interface screen that provides an overview of a container orchestration service according to illustrative embodiments.

FIG. 7A is a flow chart showing steps in a process for distributing software to a target environment according to illustrative embodiments.

FIG. 7B is a flow chart sowing steps in a process for deploying software in a target environment according to illustrative embodiments.

FIG. 8 illustrates an example of a system including a computing device and a user interface with which various components of a source environment and a target environment may be implemented according to illustrative embodiments.

### DETAILED DESCRIPTION OF THE EMBODIMENTS

According to an illustrative embodiment, methods, devices and systems are provided that leverage containerization technology to reduce the bandwidth needed to distribute software to and deploy software in a target environment.

Containerization technology allows applications with everything they need to run (e.g., source code, runtime, system tools, libraries, etc.) to be wrapped up into a single software package. Containerization guarantees that an application will run in a consistent manner, regardless of the environment in which the container is deployed.

According to illustrative embodiments, DevOps services and containerization are leveraged in conjunction with open source and custom built software tools to provide for source code integration, automated software orchestration, and user friendly infrastructure controls that minimize cost, shorten production time and improve the security and quality of software deployment.

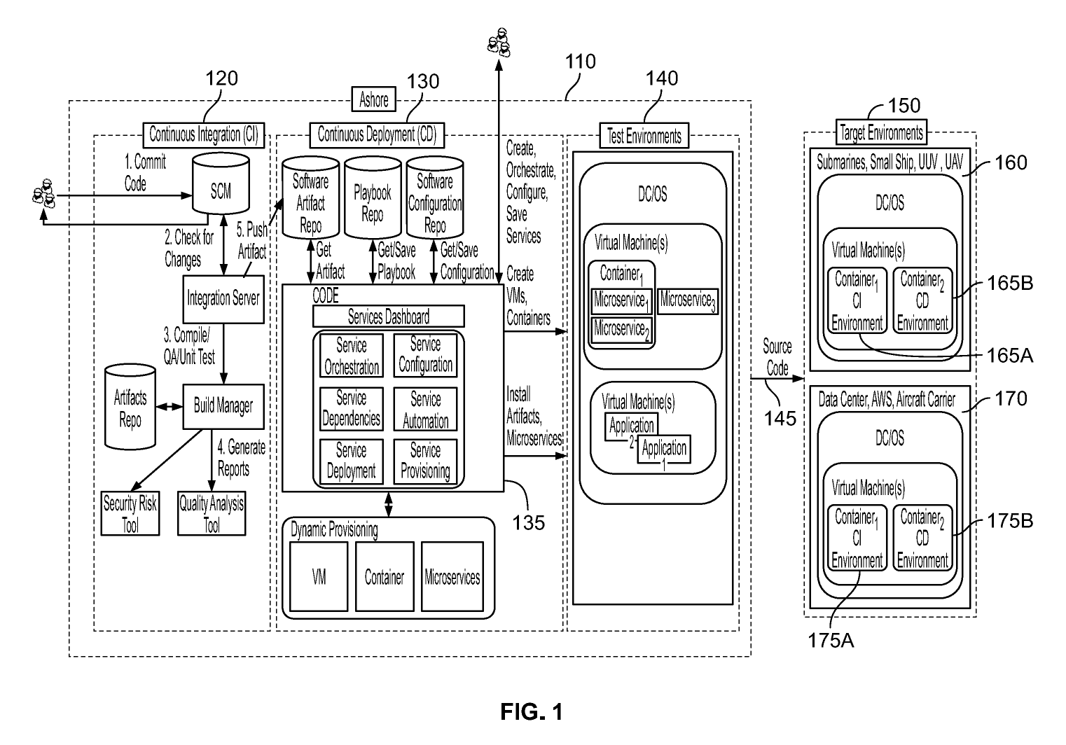

FIG. 1 illustrates an example of a secure DevOps deployment architecture for distributing and deploying software according to illustrative embodiments. Reference numerals have not been included to refer to every component in FIG. 1 in the interest of simplicity of illustration.

The secure DevOps Deployment (S2D2) architecture depicted in FIG. 1 includes a source environment 110 and target environments 150. Using the Navy as an example, the source environment 110 includes servers and computing devices that may be on shore, and the target environments 150 include servers and computing devices that are offshore, remote from the source environment 110. As shown in FIG. 1, the target environments 150 may include one or more relatively small computing systems 160, such as computing systems in submarines, small ships, unmanned underwater vehicles (UUV), unmanned aerial vehicles (UAV), etc. The target environments 150 may also include one or more larger computing systems 160, such as a data center, an Aviator Warfare System (AWS), a computing system on an aircraft carrier, etc.

The source environment 110 includes continuous integration (CI) architecture 120 and continuous deployment (CD) architecture. As those skilled in the art will appreciate, continuous integration and continuous deployment are tools that are commonly used in the development of software to reduce the time code changes spend in production. Continuous integration automates the process of receiving code changes, building executable binary files including the code changes, and scanning and testing the executable binary files. According to illustrative embodiments, continuous deployment automates the deployment of code changes into an environment by executing an application programming interface (API) on the built executable binary files.

The CI architecture 120 shown in FIG. 1 may be implemented with standard off-the-shelf CI architecture. Although one skilled in the art would understand the interconnection and operation of the various components in the CI architecture, a brief explanation is provided below to aid in understanding.

As shown in FIG. 1, the CI architecture 120 receives source code from various developers via a user interface (not shown). The source code is checked into a Software Configuration Management (SCN) database including Subversion (SVN) and Git repositories. An integration server, such as a Jenkins® integration server, retrieves checked in source code from the SCN database. A build manager server executes software, such as a Maven™ build automation tool, that performs an automated build (compile) of the source code into an executable binary file and conducts scans and tests using various plugins. The plugins extract file revisions associated with the current version of the source code. The output of the build manager is an executable binary file which may be stored in an artifacts repository managed by a binary repository manager, such as a Nexus™ repository manager.

The built executable binary file may be tested for security and quality issues. For example, the output of the build manager may be analyzed for security risks by a software tool, such as HP Fortify. The output of the build manager may also be analyzed for quality issues using a software tool, such as SonarQube®. Reports of security and/or quality issues may be generated, allowing developers to detect problems in the source code early.

With a built executable binary file in hand, the next step is to deploy the software using the CD architecture 130. The CD architecture 130 is similar in some aspects to traditional CD architecture. That is, the CD architecture 130 includes a software artifacts repository that receives and stores artifacts from the artifacts repository in the CI architecture 120. The CD architecture 130 also includes a playbook repository, such as an Ansible® playbook repository, and a software configuration. Ansible® is an open source framework that provides tools for configuration management, application deployment, and task automation. According to illustrative embodiments, the Ansible® playbooks may be used, in conjunction with custom code and scripts, to configure the executable binary files into software packages, and these configurations may be saved in the software configuration repository.

It should be appreciated that while the Ansible® framework is provided as example of a framework with which the CD architecture 130 may be implemented, the CD architecture 130 may be implemented with any suitable automation framework, e.g., Puppet®, Chef™, etc.

The process of building and deploying the source code into a software package can be daunting, especially to new users and untrained professionals. According to an illustrative embodiment, a web based application, referred to herein as the Unified DevOps Orchestration Engine (UDOE) 135, facilitates user management of virtual machines (VMs), containers, and microservice technologies. The UDOE 135 provides users with the ability to create, destroy, start, pause, and stop an instance of and/or a combination of VMs, containers, and microservice modules. The UDOE 135 adds additional security by restricting access based on credentials, such as clearance, project affiliation, etc.

As may be understood with reference to FIG. 1, the UDOE 135 is a web-based application that provides a services dashboard including various options and providing other information to the user for deploying software. The services dashboard may be presented as a website via a user interface to the users. Users can easily access the services dashboard as a website from any computer connected to the Internet using a standard browser.

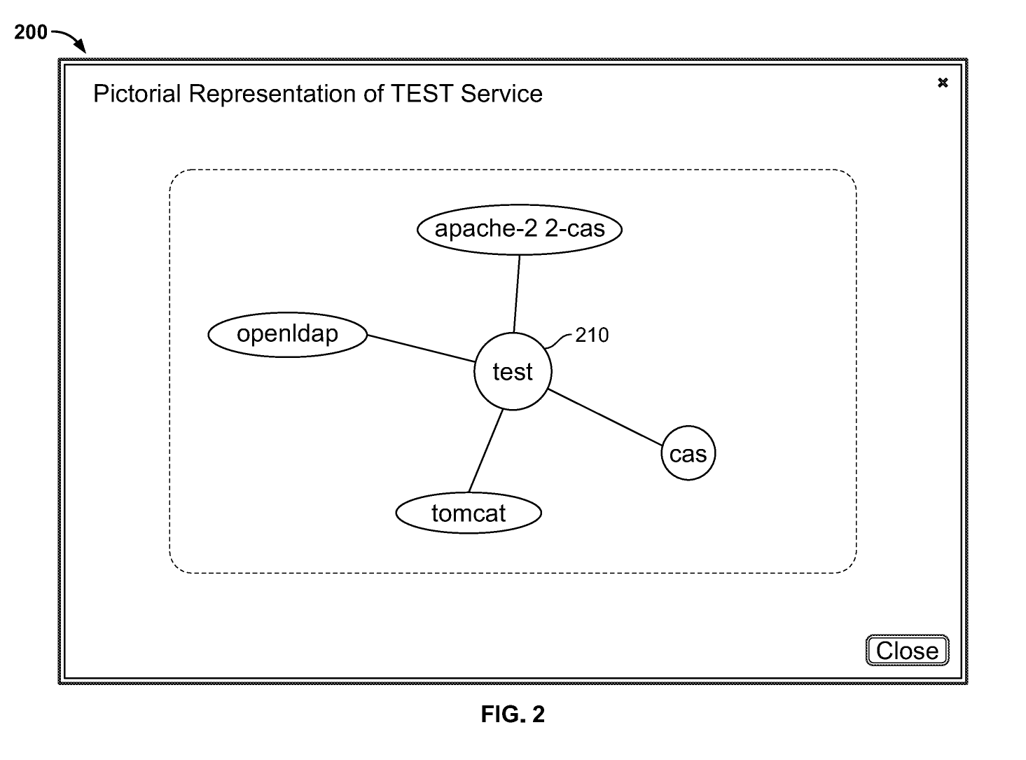

The options presented by the services dashboard include options for allowing a user to configure the binary files corresponding to the source code as services and orchestrate the configuration of services. The options presented by the services dashboard also allows users to select/create containers, VMs and/or microservice modules for which the services will be provisioned and to which the services will be deployed. Further, the services dashboard provides the user with information regarding service dependencies and service automation. Further details of the options and information presented to the users by the UDOE 135 via the services dashboard may be understood with reference to the user interface screens shown in FIGS. 2-6, described in detail below.

Responsive to user selections of configuration, provisioning, and deployment options, the executable binary files are configured as services that are dynamically provisioned to VMs, containers, and microservice modules. The VMs may be supported by a virtualization platform, such as a Kernel-based VM (KVM) virtualization infrastructure, an Elastic Sky X (ESXi) hypervisor, and a Hyper-V® hypervisor. The containers may be supported by container platforms, such as Docker™, Rocket®, etc.

Once the VMs, containers and microservice modules are created and the services are provisioned, installation of the software packages as services in the VMs, containers, and microservice modules is automatically performed. Then, testing of the software package is performed by a testing module 140 included in the source environment 110.

The testing module 140 conducts tests on the source software package including the services provisioned to various VMs, container, and microservice modules supported by a data center operating system (DC/OS), such as a Mesophere® DC/OS. After the software has been tested by the testing module 140, it is ready to deploy to the target environments 150.

According to the present invention, instead of deploying the entire software package including the built executable binary file, only the source code from which the executable binary file was built is sent to the target environments 150. This approach has numerous advantages. Sending only the source code reduces the amount of bandwidth needed to distribute the software to the target environments 150. This provides for increased efficiency in disconnected, intermittent, and limited (DIL). Also, if the source code is tampered with during transmission, the tampering is more easily detected compared to tampering of a software package.

As an alternative, instead of sending the source code, only changes between the source code and previous versions of the source code may be sent to the target environments 150. This further reduces the amount of bandwidth needed and makes it easy to track changes in the source code.

According to an illustrative embodiment, the source code may be transmitted from the source environment 110 to the target environments 150 via a link 145. The link may be any encrypted link that uses common internet protocols or proprietary protocols.

With security in mind, the source code may be encrypted and broken into packets before it is transmitted over the link 145. To prevent tampering of the source code and the executable binary files that will be built from the source code in the target environments 150, hashes of both the source code and the executable binary files built in the source environment 110 may be calculated. These hashes can be sent from the source environment 110 to the target environments 150 over a channel different than the link 145, such as secure email, phone, etc., and can be used to guarantee the source code has not been tampered with or corrupted during transmission. After the software source code reaches the target environments 150, a hash can be computed and compared to the hash computed at the source environment 110 to make sure the package was delivered successfully. Once the source code package is verified (before and after decrypting) it can be built.

According to illustrative embodiments, containerization and automation are leveraged to guarantee common CI and CD environments in the source and target environments, which results in a repeatable and auditable installation process. That is, as shown in FIG. 1, the CI architecture 120 included in the source environment 110 is replicated as a CI framework 165A in a container in the target environment 160 and as CI framework 175A in a container in the target environment 170. Also, the CD architecture 130 in the source environment 110 is replicated as CD framework 165B in another container in the target environment 160 and as CD framework 175B in another container in the target environment 170.

By replicating the CI architecture 120 in the source environment as the CI framework 165A, 175A in the target environments, a common build environment is guaranteed. Thus, the result of the integration process performed by the CI frameworks 165A, 165B will be executable binary files that are identical to the executable binary files built, scanned, and tested in the source environment 110. To guarantee the security and functionality of the executable binary files produced by the CI frameworks 165A, 165B, a hash of these files may be computed and compared to the computed hash of the executable binary files produced by the Ci architecture 120 in the source environment.

In this manner, containerization technology is leveraged to host the integration and deployment infrastructure in the target environments 150. This guarantees a common build environment for the source environment 110 and the target environments 150. Also, the use of containerization technology allows services to be deployed to VMs and containers that can be easily be replaced. This reduces down time when deploying new source code, since the target environments 150 do not need to be taken offline. Further, the use of containerization technology optimizes the use of available hardware resources and eliminates the need to have dedicated build servers or computing devices.

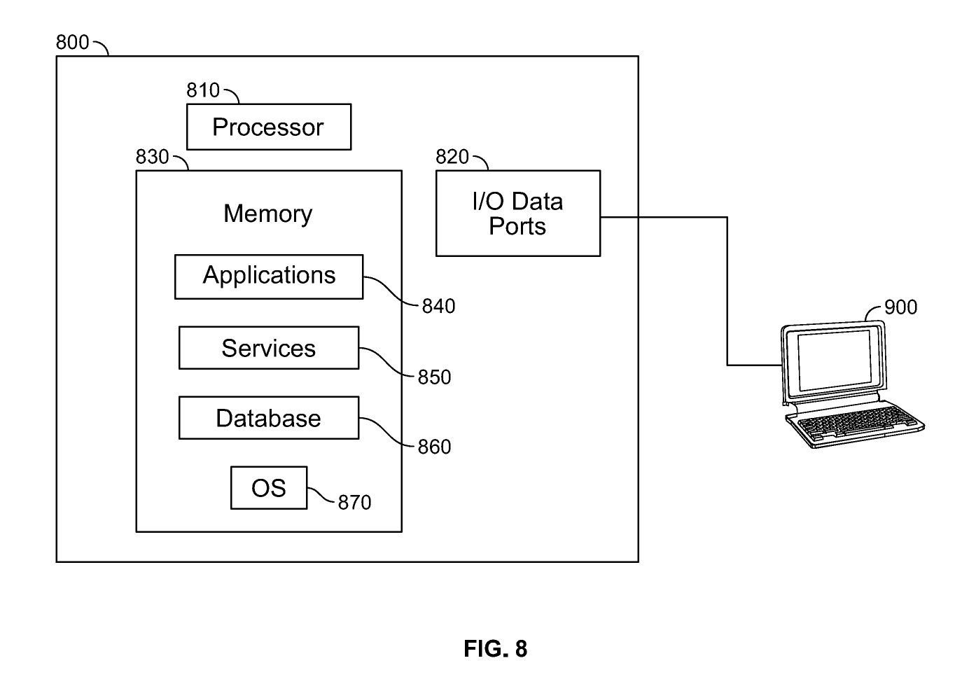

It should be appreciated that the various components of the source CI architecture 120 and the source CD architecture 130, as well as the CI frameworks 165A, 175A and the CD frameworks 165B, 175B may be included in one more servers or computing devices, such as the computing device described in detail below with reference to FIG. 8.

Like the CD architecture 130 in the source environment 110, the CD frameworks 165B and 175B in the target environments 160 and 170, respectively, provide a UDOE (not shown in the target environments for simplicity of illustration). Both UDOEs are collectively referred to herein as the UDOE 135. Using the UDOE 135 provided in the target environments 150, users in the target environments 150 are provided with options for configuring and provisioning services, in a manner similar to that which is provided to users in the source environment 110. The UDOE 135 provides users with a high-level overview of containers and VMs with visualization tools that make it easy for user to monitor the containers and VMs.

Upon logging into the UDOE 135, the user is provided with an overview of system resources and availability via a user interface. The user is then able to create VMs and containers on the fly with little to no user interaction. Although VMs are referred to in the following description, it should be appreciated that the description is similarly applicable to containers.

Using a VM as an example, the user may create a VM by filling out a form via a user interface. The form includes user information and VM options. When the user submits the form, selecting options for creating the VM, the UDOE 135 submits a REpresentational State Transfer (REST) call to an API with the specified information. Upon receiving this information, the API executes a set of scripts that initializes the creation of the VM. The VM is automatically installed without further input from the user. The user can check the progress of the VM from the user interface, which will provide the status of the VM. From the user interface, the user may start, stop, or delete machines, take snapshots, or open up a remote session.

The UDOE 135 makes it extremely easy to install complicated software services by automatically providing the user with prerequisites needed for configuring services and allowing the user to save configurations via the user interface. Once a configuration is set up, the software services may be deployed through a software automation tool, such as an Ansible® tool, as described above. The Ansible® framework seamlessly automates the process of installing software on remote systems. The installation process is transparent to the user, although the user still has the ability to see the progress of the installation when the configuration is deployed.

Additionally, the UDOE 135 allows a user to better visualize a configuration of a service by providing a graphical representation of the configuration via a user interface. An example of a pictorial representation of a configuration is depicted as a user interface screen 200 in FIG. 2. As shown in FIG. 2, the pictorial representation captures the dependencies of other services on a “test” service 210. This lets the user know that if the “test” service 210 is selected for installation, the services that are dependent on it, including apache-2.2-cas, open app, case, and tomcat, will also be installed.

After configuring a service, the user can choose a deployment environment by building a configuration using the user interface. The user has the freedom of either choosing a single environment or multiple environments, which further streamlines the process of setting up multiple VMs.

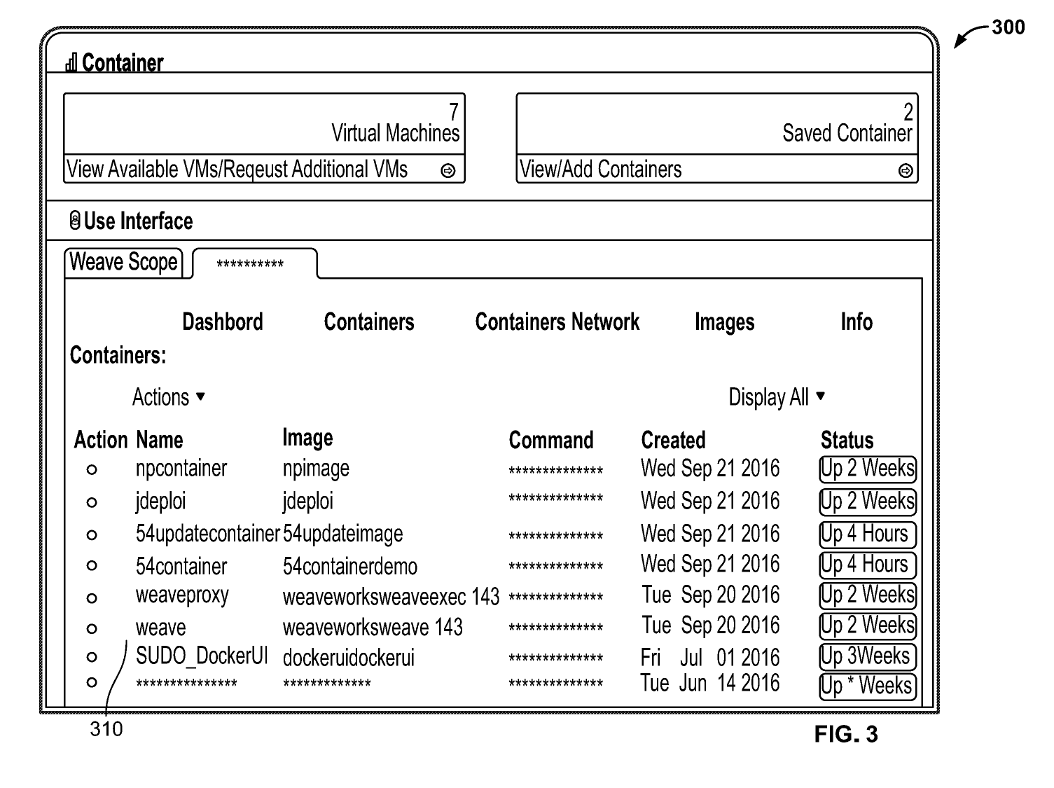

The UDOE 135 also provides the user with the ability to monitor VM and container usage, utilization, and relationships via a user interface screen, such as the screen 300 depicted in FIG. 3. Using the list 310 of containers in use, such as that depicted in FIG. 3, the user is able to monitor container usage from the same web-based user interface that allowed the user to spawn and deploy services to the containers.

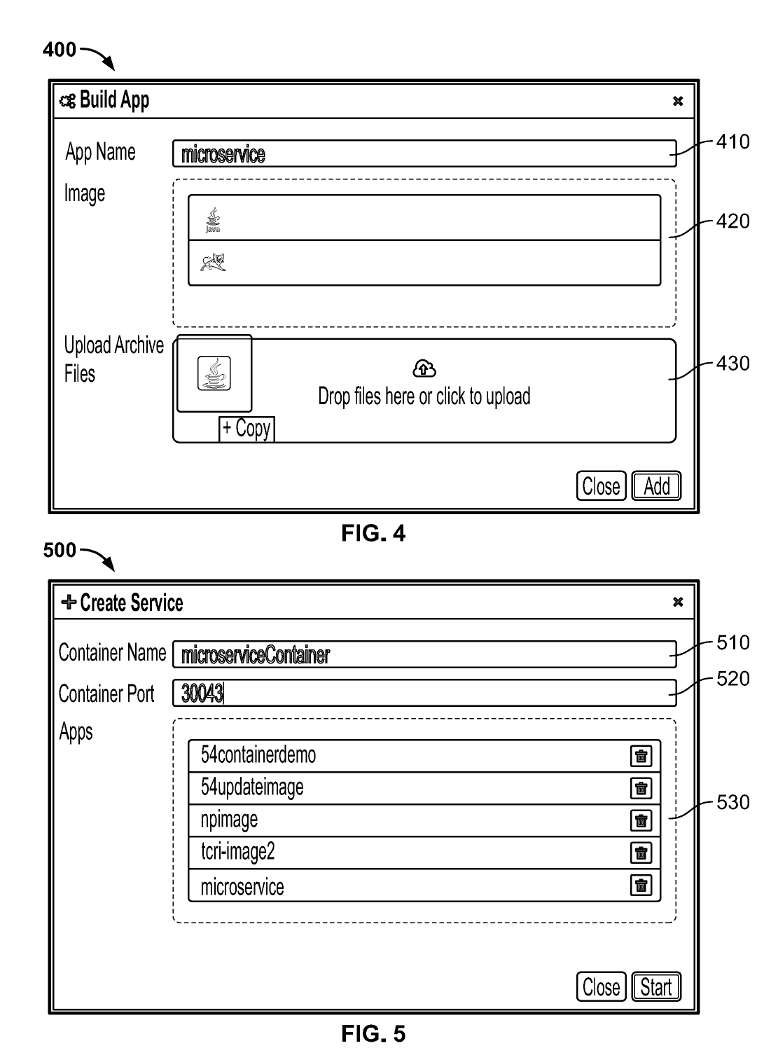

In addition to allowing the user to create VMs and containers on the fly, the UDOE 135 also allows users to create microservice modules on the fly using a user interface screen, such as the screen 400 depicted in FIG. 4. Referring to FIG. 4, a user starts off by building a microservice image by inputting a microservice name in a dialog box 410. The user interface screen 400 conveniently allows the user to select a base container image with the desired specifications (e.g., Java™, Apache Tomcat™, etc.) from a list of base container images 420. After selecting the base image, the user can navigate to the directory of the service the user wants to deploy, such as jar or war file. Alternatively, to streamline deployment, the user can simply drag and drop the base image onto the portion 430 of user interface screen 400.

Once the user navigates to the service directory or drags and drops the base image, the UDOE 135 submits a REST call to an API, which then dynamically generates a Dockerfile (the instructions for creating a Docker™ image) and creates the image. The user can then move on to creating the service and selecting an available port to deploy the service using a user interface screen, such as the screen 500 depicted in FIG. 5.

Referring to FIG. 5, with the user interface screen 500, the user can specify the container name using the dialog box 510 and specify the port using the dialog box 520. A list of microservice provisioned for that container may be shown in a portion 530 of the screen 500. Responsive to the user input, the UDOE 135 then initiates another REST call that runs a set of scripts that creates the container based on the given image and port.

The modular architecture of the UDOE 135 allows the integration of various container orchestration services. For example, Docker™ orchestration services, such as Kubernetes®, Apache Mesos™, Docker Swarm™, etc., can be integrated within the UDOE 135 as if they were plugins. Depending on the configuration, they could be swapped in and out as if they were building blocks. Once integrated, the UDOE 135 can provide a high-level overview of these orchestration services.

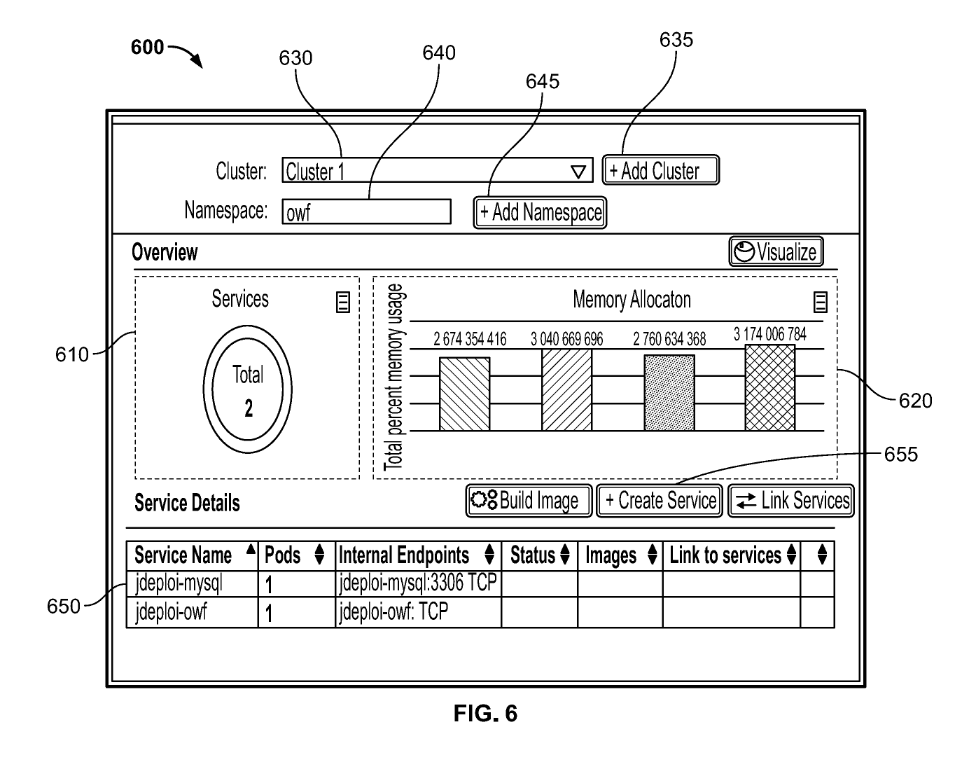

For illustrative purposes, FIG. 6 depicts a user interface screen that demonstrates the integration of the Kubernetes® container orchestration service into UDOE 135. As those skilled in the art will appreciate, Kubernetes® is an open-sourced solution for automating the deployment, scaling, and management of a cluster of containerized applications. The screen 600 shown in FIG. 6 provides an overview of the Kubernetes® container orchestration service. The screen 600 allows the user to create a Kubernetes® cluster on the fly.

On the user interface screen 600, the user is shown a number of services residing on each namespace in a portion 610. The overall memory allocation of each cluster is shown in a portion 620. Using the user interface screen 600, the user is also able to create new clusters using the dialog box 630 and the “add cluster” button 635, add additional namespaces using the dialog box 640 and the “add namespace” button 645, and deploy new services by using a “create service” button 655 to add services to the list 650. The user interface screen 600 is designed to make it easy for the users to quickly add or remove clusters without requiring prior experience with Kubernetes®.

Users can also deploy services to a specified Kubernetes® cluster in the same manner as when creating a microservice. Load balancing and the selection of where each service goes on the cluster are all transparent to the user, since they are managed by Kubernetes® in the background. Although Kubernetes® is described as an example of an orchestration service, the UDOE 135 can provide similarfunctionality with other orchestration services.

Although not shown, the UDOE 135 also provides a logging interface that allows for monitoring logs of user events, such as the modification of VMs and containers, services that are running, etc. This provides another layer of security that allows administrators to monitor when certain events take place. Information logged through the logging interface may be customizable. Logs may be stored in a database, and separate log files may be provided for redundancy and added security.

The UDOE 135 leverages a modular design and new features can be added easily. Future technologies that could be added include hardware monitoring of the physical servers, networking configuration, custom VM image upload and deployment, etc.

It should be appreciated that the user interface screens depicted in the figures and described herein are given by way of example. The user interface provided by the UDOE 135 may include different and additional screens. Also, instead of being web-based, the UDOE 135 may be implemented with a thick client.

Further, although some examples have been provided above of various open source platforms and frameworks, the S2D2 architecture described herein works with all types of hardware, platforms, and software architecture. For example, the VM and hypervisor layers described above may be replaced by bare metal machines. Also, the architecture shown in FIG. 1 may be cloud-based.

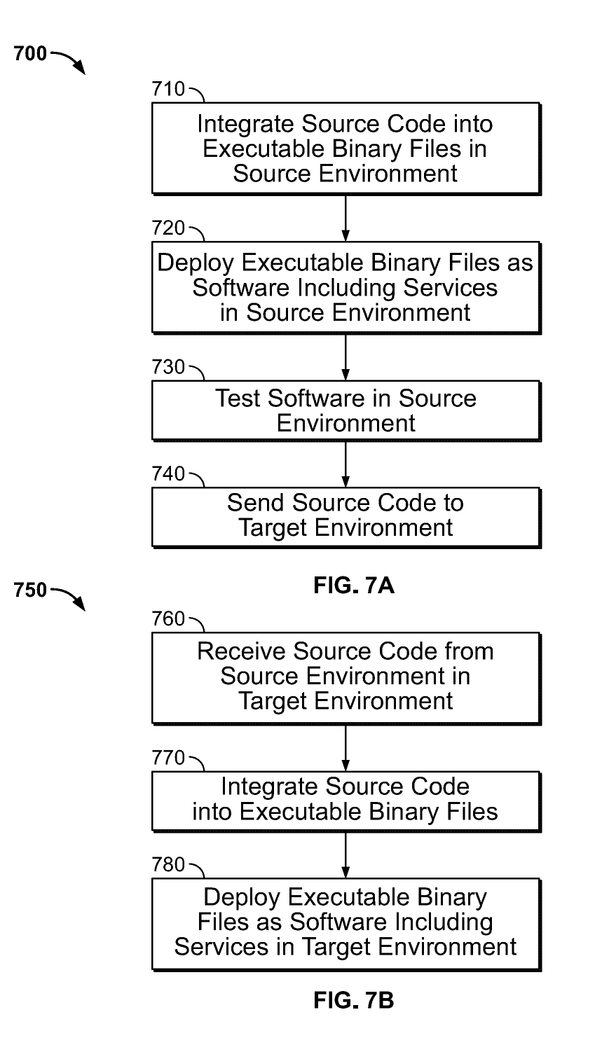

FIG. 7A is a flow chart showing steps in a process for distributing software to a target environment, and FIG. 7B is a flow chart showing steps in a process for deploying software in a target environment according to illustrative embodiments. It should be appreciated that the steps and order of steps described and illustrated are provided as examples. Fewer, additional, or alternative steps may also be involved in the process and/or some steps may occur in a different order.

Referring to FIG. 7A, the process 700 for distributing the software to the target environment begins at step 710 at which source code received from developers is integrated into executable binary files. This step may be performed by, e.g., the CI architecture 120 in the source environment 110 shown in FIG. 1. At step 720, the executable binary files are deployed as source software including services by, e.g., the CD architecture 130 in the source environment. At step 730, the deployed source software in the source environment 110 is tested by, e.g., the testing module 140. Once the source software is validated, only the source code from which the executable binary files were built in the source environment 110 is sent to the target environment, such as one or more of the target environments 150 shown in FIG. 1, at step 740.

Referring to FIG. 7B, the process 750 for deploying software to a target environment, such as one or more of the target environments 150 shown in FIG. 1, begins at step 760 at which the source code is received from the source environment. At step 770, the received source code is integrated into executable binary files. This step may be performed by replicated and containerized CI architecture, such as one or more of the CI frameworks 165A, 165B shown in FIG. 1. At step 780, executable binary files are deployed as target software including services in the target environment. This step may be performed by replicated and containerized CD architecture, such as one or more of the CD frameworks 175A, 175B shown in FIG. 1.

It should be appreciated that the steps 770 and 780 in the process 750 are similar to the steps 710 and 720 shown in the process 700, the difference being that the source code in the process 700 is input into the source environment from developers, while the source code in the process 750 is output from the source environment to the target environment.

FIG. 8 is a block diagram of a system including a computing device and a user interface with which various components of the source environment 110 and/or the target environment 150 depicted in FIG. 1 may be implemented, according to illustrative embodiments. Although no connections are shown between the components illustrated in the computing device 800 of FIG. 8, those skilled in the art will appreciate that the components can interact with each other via any suitable connections to carry out device functions.

The term “application”, or variants thereof, is used expansively herein to include routines, program modules, program, components, data structures, algorithms, and the like. Applications can be implemented on various system configurations, including single-processor or multiprocessor systems, minicomputers, mainframe computers, personal computers, handheld-computing devices, microprocessor-based, programmable consumer electronics, combinations thereof, and the like. The terminology “computer-readable media” and variants thereof, as used in the specification and claims, includes non-transitory storage media. Storage media can include volatile and/or non-volatile, removable and/or non-removable media, such as, for example, RAM, ROM, EEPROM, flash memory or other memory technology, CDROM, DVD, or other optical disk storage, magnetic tape, magnetic disk storage, or other magnetic storage devices or any other medium that can be used to store information that can be accessed.

Referring to FIG. 8, the computing device 800 may be implemented in any suitable computing device, e.g., a consumer laptop or a server. The computing device 800 includes a processor 810 that receives inputs and transmits outputs via I/O data ports 820. The I/O data ports 820 can be implemented with, e.g., an antenna or other suitable type of transceiver through which data and signals may be received and transmitted wired and/or wirelessly. As an example, the inputs received the I/O data ports 820 may include user selected options received from a user interface 900. Outputs from the I/O data ports 820 may include options to be presented to the user via the user interface 900. The user interface 900 may include a display unit with a keyboard and/or a touch screen for presenting options to users for configuring and provisioning services and allowing the users to select the options.

In the case of a computing device in the source environment 110 shown in FIG. 1, the input received at the I/O data ports 820 may also include source code received from developers, and the output may also include source code to be sent to the target environments 150. In the case of a computing device in the target environments 150 shown in FIG. 1, the input received at the I/O data ports may also include source code received from the source environment 110.

Although not shown, the computing device 800 may also include a physical hard drive. The processor 810 communicates with the memory 830 and the hard drive via, e.g., an address/data bus (not shown). The processor 810 can be any commercially available or custom microprocessor. The memory 830 is representative of the overall hierarchy of memory devices containing the software and data used to implement the functionality of the device 800. The memory 830 can include, but is not limited to the types of memory devices described above. As shown in FIG. 8, the memory 830 may include several categories of software and data used in the device 800, including applications 840, services 850, a database 860, an operating system (OS) 870, etc.

The applications 840 and services 850 can be stored in the memory 830 and/or in a firmware (not shown) as executable instructions, and can be executed by the processor 810. The applications 840 include various programs that implement the various features of the device 800, including, e.g., applications for providing virtual machines, containers, and microservice modules, applications for executing CI and CD tasks, applications for testing deployed software, etc. The services 850 include various configured and provisioned services as described above.

The database 860 represents the static and dynamic data used by the applications 840, the services 850, the OS 870, the I/O data ports 820 and other software programs that may reside in the memory. The database may 860 may be used to store various data including data needed to execute the applications 840, e.g., source code artifact repository data, service dependencies, available configuration and provisioning options, selected configuration and provisioning options, etc. The database 860 may also be used to store other data, such as user event logs.

While the memory 830 is illustrated as residing proximate the processor 810, it should be understood that at least a portion of the memory 830 can be a remotely accessed storage system, for example, a server on a communication network, a remote hard disk drive, a removable storage medium, combinations thereof, and the like.

While only one computing device 800 and one user interface 900 are shown in FIG. 8, it should be appreciated that multiple computing devices and user interfaces may be used in the source environment 110 and/or the target environments 150. It should further be understood that FIG. 8 and the description above are intended to provide a brief, general description of a suitable environment in which the various aspect of some embodiments of the present disclosure can be implemented. While the description includes a general context of computer-executable instructions, the present disclosure can also be implemented in combination with other program modules and/or as a combination of hardware and software in addition to, or instead of, computer readable instructions.

It will be understood that many additional changes in the details, materials, steps and arrangement of parts, which have been herein described and illustrated to explain the nature of the invention, may be made by those skilled in the art within the principle and scope of the invention as expressed in the appended claims.

What is claimed is:

1. A method for deploying software in a target environment, comprising:
receiving source code that is part of a source software package from a source environment that is remote from the target environment;
integrating the source code in the target environment into executable binary files using target continuous integration (CI) architecture that is a replica of source CI architecture used to integrate the source code in the source environment, wherein the target CI architecture is included in a container in the target environment; and
deploying the executable binary files in the target environment using continuous deployment (CD) architecture that is a replica of source CD architecture used to deploy the source code in the source environment, wherein the target CD architecture is included in another container in the target environment.

2. The method of claim 1, wherein receiving the source code includes receiving only changes made to the source code in the source environment.

3. The method of claim 1, wherein integrating the source code includes building the source code into executable binary files and scanning and testing executable binary files.

4. The method of claim 3, wherein deploying the executable binary files includes configuring the executable binary files into services and provisioning the configured services.

5. The method of claim 4, wherein deploying the executable binary files further comprises creating instances of at least one of virtual machines and containers and provisioning the services in at least one of the virtual machines and containers.

6. The method of claim 4, wherein deploying the executable binary files further comprises provisioning the services in microservice modules.

7. The method of claim 1, further comprising presenting for display options for deploying the executable binary files and receiving data indicative of selected options.

8. The method of claim 7, wherein the options include options for orchestrating configuration of the executable binary files into services and options for provisioning the services.

9. The method of claim 7, wherein the executable binary files are deployed based on the selected options.

10. A device for deploying software in a target environment, comprising:
an input interface configured to receive source code that is part of a software package from a source environment;
target continuous integration (CI) architecture configured to build the received source code into target executable binary files and scan and test the target executable binary files in the target environment, wherein the target CI architecture is a replica of source CI architecture configured to build the source code into source executable binary files and scan and test the source executable binary files in the source environment, and wherein the target CI architecture is included in a container in the target environment;
a user interface configured to present options for deploying the target executable binary files and receive data indicative of selected options for deploying the target executable binary files; and
target continuous deployment (CD) architecture configured to perform deployment of the target executable binary files in the target environment based on the selected options, wherein the target CD architecture is a replica of source CD architecture configured to perform deployment of the source executable binary files in the source environment, and wherein the target CD architecture is included in another container in the target environment.

11. The device of claim 10, wherein the input/output interface is configured to receive only changes made to the source code in the source environment.

12. The device of claim 10, wherein deployment of the executable binary files includes configuring the executable binary files into services and provisioning the configured services.

13. The device of claim 12, wherein deployment of the executable binary files further comprises creating instances of at least one of virtual machines and containers and provisioning the services for execution in at least one of the virtual machines and containers.

14. The device of claim 12, wherein deployment of the executable binary files further comprises provisioning the services for execution in microservice modules.

15. The device of claim 10, wherein the options for deploying the executable binary files presented via the user interface include options for orchestrating configuration of the executable binary files into services and options for provisioning the services.

16. A system for distributing software from a source environment to a remote target environment, comprising:
source continuous integration (CI) architecture configured to build source code into source executable binary files and scan and test the source executable binary files in the source environment;
a user interface configured to present options for configuring and provisioning the source executable binary files and receive data indicative of selected options;
source continuous deployment (CD) architecture configured to configure and provision the source executable binary files into a source software package including executable in the source environment based on the selected options;
a testing module configured to validate the source software package in the source environment; and
an output interface configured to send only the source code via a communication link to the target environment, wherein the target environment includes a CI container including a replica of the source CI architecture for building the received source code into target executable binary files and scanning and testing the target executable binary files in the target environment and a CD container including a replica of the source CD architecture for configuring and provisioning the target executable binary files into a target software package including services that are executable in the target environment.

17. The system of claim 16, wherein the output interface is configured to send only changes in source code to the target environment.

18. The system of claim 16, wherein the source CD architecture is further configured to create instances of at least one of virtual machines and containers and provision the source executable files into services that are executable in at least one of the virtual machines and containers.

19. The system of claim 16, wherein the source CD architecture is further configured to provision the source executable binary files into services that are executable in microservice modules.

20. The system of claim 16, wherein the options presented by the user interface for configuring and provisioning the source executable binary files in the source environment are also presented by a user interface in the target environment for configuring and provisioning the target executable binary files.
